(19) United States
(12) Patent Application Publication
(10) Pub. No.: US 2014/0365109 A1
(43) Pub. Date: Dec. 11, 2014

(54) APPARATUS AND METHOD FOR RECOGNIZING DRIVING LANE

(71) Applicant: Hyundai Motor Company, Seoul (KR)

(72) Inventors: Byung Yong You, Suwon (KR); Young Chul Oh, Seongnam (KR); Tae Sung Choi, Sacheon (KR); Su Rim Kwon, Yongin (KR)

(73) Assignee: Hyundai Motor Company, Seoul (KR)

(21) Appl. No.: 14/050,632

(22) Filed: Oct. 10, 2013

(30) Foreign Application Priority Data
Jun. 10, 2013 (KR) 10-2013-0065786

(51) Int. Cl. G01C 21/28

(52) U.S. Cl. CPC G01C 21/28
USPC 701/409

(57) ABSTRACT

An apparatus and a method for recognizing a driving lane are provided and include a processor that is configured to detect driving environment information acquired by a plurality of driving environment information collecting devices installed within a vehicle. In addition, the processor is configured to determine the driving lane in which the vehicle is currently traveling by combining at least two pieces of the detected driving environment information and output the recognized driving lane information as a result of the determination.

### CROSS-REFERENCE TO RELATED APPLICATION

This application is based on and claims priority from Korean Patent Application No. 10-2013-0065786, filed on Jun. 10, 2013 in the Korean Intellectual Property Office, the disclosure of which is incorporated herein in its entirety by reference.

### BACKGROUND

1. Field of the Invention

The present invention relates to an apparatus and a method for recognizing a driving lane, and, more particularly, to an apparatus and a method for recognizing the driving lane by combining different types of information regarding a driving environment.

2. Description of the Prior Art

As advanced driver assistance system (ADAS) maps are increasingly being used, it is an important issue for a driver to determine which driving lane in a precise map the vehicle is located in. Even though such a precise map provides various pieces of information, it may still be difficult to precisely detect which of the driving lanes a driver's vehicle is located in, due to the limitation of a global positioning system (GPS). For example, when using a distance sensor to recognize a driving lane, boundaries must be recognized on both sides of the entire lanes whichever lane the vehicle is traveling in and information regarding the width of each of the lanes must be obtained. To precisely recognize the driving lane, a sensor capable of detecting all around the vehicle such as a three-dimensional (3D) LiDAR is required, which is expensive and is separately installed.

### SUMMARY

The present invention provides an apparatus and a method for accurately recognizing the driving lane of a vehicle by combining different pieces of information acquired by a plurality of collecting devices installed within the vehicle.

In addition, the present invention provides an apparatus and a method that recognizes the driving lane using collecting devices installed within a vehicle without requiring additional equipment for recognizing lines of lanes.

In one aspect of the present invention, an apparatus for recognizing the driving lane is provided and may include: a driving environment detector that detects pieces of driving environment information acquired by a plurality of driving environment information collecting devices installed within a vehicle; a driving lane determiner that determines the driving lane in which the vehicle is currently traveling by combining at least two pieces of the detected driving environment information; and output unit that outputs recognized driving lane information as a result of the determination.

The plurality of driving environment information collecting devices may include a navigator, an imaging device (e.g., a camera), and a sensor. The driving environment detector may detect the number of total lanes on a driving road based on the information acquired from the navigator, and may detect at least one of a line type of a driving lane or an adjacent lane, an adjacent vehicle, a road boundary and a median strip based on the driving environment information acquired from the camera or the sensor. The driving lane determiner may recognize the first or last lane based on at least one of whether the line type of the driving lane or adjacent lane is a solid or dashed line, the side on which the solid line exists, and the color of the lines, and determine the driving lane with reference to the number of total lanes and the recognized first or last lane.

The driving lane determiner may determine the driving lane based on the number of total lanes and a preceding vehicle traveling in the left or right lane or the position of an opposing vehicle traveling in the opposite way. In addition, the driving lane determiner may recognize the first or last lane based on the position of the road boundary or the median strip, and determine the driving lane with reference to the number of total lanes and the recognized first or last lane.

In another aspect of the present invention, a method for recognizing the driving unit is provided and may include: detecting, by a processor, pieces of driving environment information acquired by a plurality of driving environment information collecting devices installed within a vehicle; determining, by the processor, the driving lane in which the vehicle is currently traveling by combining at least two pieces of the detected driving environment information; and outputting, by the processor, recognized driving lane information as a result of the determination.

The detecting of the driving environment information may include detecting the number of total lanes on a driving road based on the information acquired from the navigator, and detecting at least one of a line type of a driving lane or an adjacent lane, an adjacent vehicle, a road boundary and a median strip based on the driving environment information acquired from the camera or the sensor.

The determining of the driving lane may include recognizing the first or last lane based on at least whether the line type of the driving or adjacent lane is a solid or dashed line, the side on which the solid line exists, and the color of the lines, and determining the driving lane with reference to the number of total lanes and the recognized first or last lane. In addition, the determining of the driving lane may include determining the driving lane based on the number of total lanes and a preceding vehicle traveling in the left or right lane or the position of an opposing vehicle traveling in the opposite way. Further, the determining of the driving lane may include recognizing the first or last lane based on the position of the road boundary or the median strip, and determining the driving lane with reference to the number of total lanes and the recognized first or last lane.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary block diagram illustrating the configuration of an apparatus for recognizing the driving lane according to an exemplary embodiment of the present invention;

FIG. 2 is an exemplary block diagram for illustrating the detailed configuration of the driving environment detector of FIG. 1 according to an exemplary embodiment of the present invention;

FIGS. 3A to 3D are exemplary diagrams for illustrating driving environment information according to an exemplary embodiment of the present invention;

FIGS. 4A-4F are exemplary diagrams for illustrating the operation of recognizing the driving lane according to exemplary embodiments of the present invention;

FIGS. 5A-5J are exemplary diagrams for illustrating the operation of recognizing the driving lane according to exemplary embodiments of the present invention;

FIGS. 6A-6N are exemplary diagrams for illustrating the operation of recognizing the driving lane according to exemplary embodiments of the present invention; and

FIG. 7 is an exemplary flow chart illustrating an operation flow of a method for recognizing the driving lane according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, embodiments of the present invention will be described with reference to the accompanying drawings.

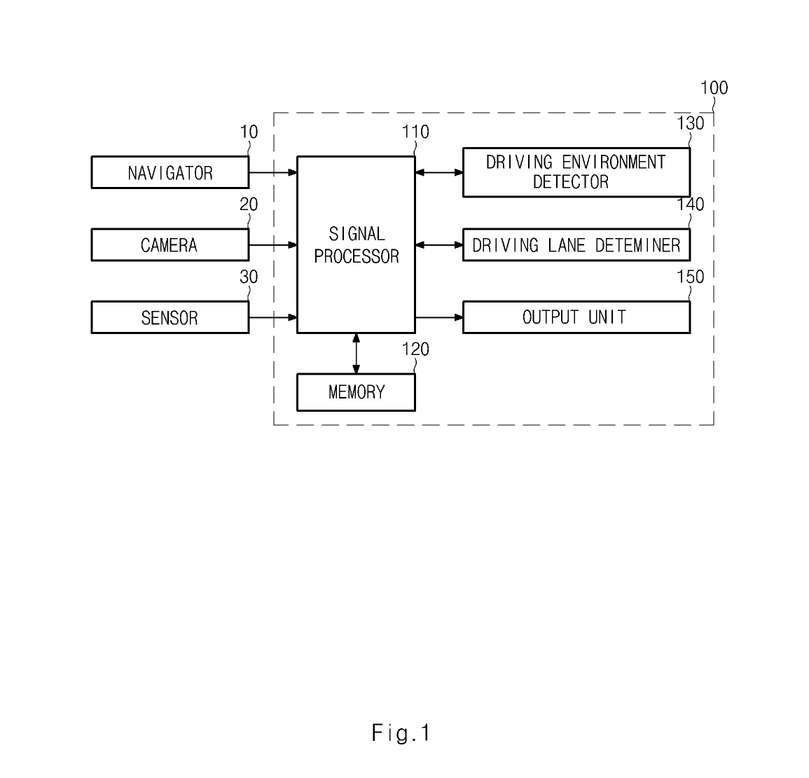

FIG. 1 is an exemplary block diagram illustrating the configuration of an apparatus for recognizing the driving lane according to an exemplary embodiment of the present invention The apparatus for recognizing the driving lane 100 according to the exemplary embodiment of the present invention may be connected to a plurality of driving environment information collecting devices, e.g., a navigator 10, a camera 20 and sensor 30, and may be provided with pieces of information regarding a driving environment acquired by each of the plurality of driving environment collecting devices.

In particular, the apparatus for recognizing the driving lane 100 may include a signal processor 110, a memory 120, a driving environment detector 130, a driving lane determiner 140 and an output unit 150, as shown in FIG. 1. The signal processor 110 may be configured to process signals from each of the components in the apparatus 100. The memory 120 may be configured to store therein setting values for recognizing driving lanes by the apparatus 100, for example. Further, the memory 120 may be configured to store therein pieces of information regarding the driving environment provided by each of the plurality of driving environment information collecting devices, and may be configured to store therein results of recognizing driving lanes.

The driving environment detector 130 may be configured to detect each piece of information of the driving environment acquired by each of the plurality of driving environment information collecting devices. In other words, the driving environment detector 130 may be configured to detect the number of total lanes on the road based on the map information acquired by the navigator 10. Further, the driving environment detector 130 may be configured to detect lines of driving lane or adjacent lanes in front, or may be configured to detect front or adjacent vehicles based on the image information acquired by the camera 20. Further, the driving environment detector 130 may be configured to detect front or adjacent driving vehicles, road boundaries, and median strips based on the image information acquired by the sensor 30.

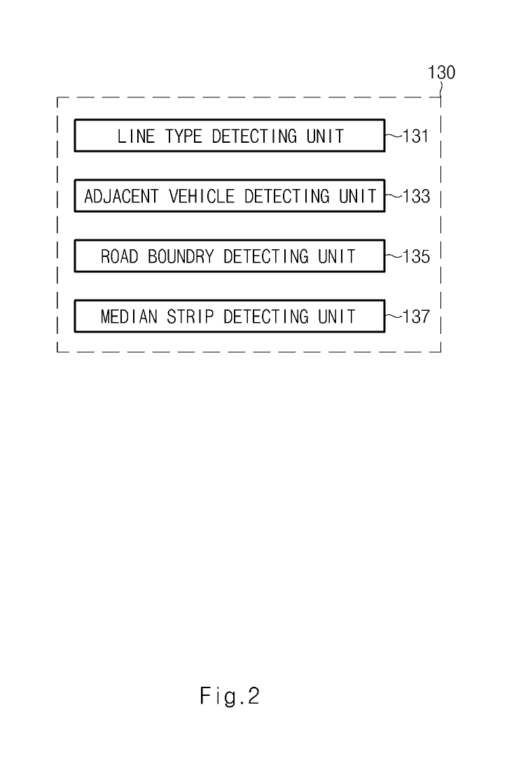

As shown in FIG. 2, the driving environment detector 130 may include a line type detecting unit 131, an adjacent vehicle detecting unit 133, a road boundary detecting unit 135, and a median strip detecting unit 137.

The line type detecting unit 131 may be configured to detect the line type of driving lane or adjacent lane based on an image acquired by the camera 20. For example, the line type detecting unit 131 may be configured to detect whether the line type of driving lane in front is a solid line or a dashed line, the color of the line, and the like. Further, the line type detecting unit 131 may be configured to detect whether the line type of adjacent lanes on both sides are solid lines or dashed lines.

The adjacent vehicle detecting unit 133 may be configured to detect vehicles in front of the vehicle based on an image acquired by the camera 20 or sensor values from sensor 30. For example, the adjacent vehicle detecting unit 133 may be configured to detect vehicles in front of the vehicle, and vehicles in the left and right lanes. In addition, the adjacent vehicle detecting unit 133 may be configured to detect a vehicle in a wider range based on the number of lanes and the detecting range of the sensor 30 or the camera 20.

The road boundary detecting unit 135 may be configured to detect road boundaries positioned on outer lanes which are positioned closer to sidewalks based on an image acquired by the camera 20 or the sensor values from sensor 30. The median strip detecting unit 137 may be configured to detect median strips positioned in the first lane side based on an image acquired by the camera 20 or sensor values from sensor 30.

Further, the driving lane determiner 140 of the apparatus for recognizing the driving lane 100 may be configured to determine a driving lane on which the vehicle is currently traveling by combining at least two pieces of driving environment information detected by the driving environment detector 130. In particular, the driving lane determiner 140 may be configured to determine a driving lane on which the vehicle is currently traveling by combining the number of total lanes on a road detected by the driving environment detector 130 and the information on the line type of driving lane detected from a front image. For example, when the number of total lanes is four and the left line of driving lane is a solid line, the driving lane determiner 140 may be configured to determine the current driving lane is the first lane. When the right line of driving lane is a solid line, the driving lane determiner 140 may be configured to determine the current driving lane is the fourth lane. The above example is applied to driving on the right side of roads such as in Korea and other countries, and it may be inversely applied to driving on the left side of roads such as in Japan and other countries.

The driving lane determiner 140 may be configured to determine the current driving lane by combining the number of total lanes and information regarding the line type of adjacent lanes. For example, when the total number of lanes is four and the line type of left adjacent lane is a solid line, the driving lane determiner 140 may be configured to determine that the current driving lane is the second lane, and when the line type of the right adjacent lane is a solid line, the driving lane determiner 140 may be configured to determine the current driving lane is the third lane.

Further, the driving lane determiner 140 may be configured to determine the current driving lane by combining the number of total lanes and information regarding adjacent vehicle position. For example, when the number of total lanes is three and there is a vehicle in front and two vehicles each in one of two lanes on right side, the driving lane determiner 140 may be configured to determine that the current driving lane is the first lane, and when there are vehicles each in one of lanes on the left and right sides, respectively, the driving lane determiner 140 may be configured to determine the current driving lane is the second lane. Similarly, when there are vehicles each in one of two lanes on the left side, the driving lane determiner 140 may be configured to determine that the current driving lane is the third lane. As another example, the driving lane determiner 140 may be configured to determine the current driving lane based on the position of a vehicle approaching from an opposite lane.

Further, the driving lane determiner 140 may be configured to determine the current driving lane by combining the number of total lanes and information regarding road boundary or median strip position. For example, when the number of total lanes is three and it is detected that a median strip is located next to the left lane, the driving lane determiner 140 may be configured to determine the current driving lane is the second lane. Alternatively, when it is detected that a road boundary is located next to the right driving lane, the driving lane determiner 140 may be configured to determine that the current driving lane is the third lane.

In the above-described example, two pieces of information have been combined; however, three or more pieces of information may be combined to determine the current driving lane.

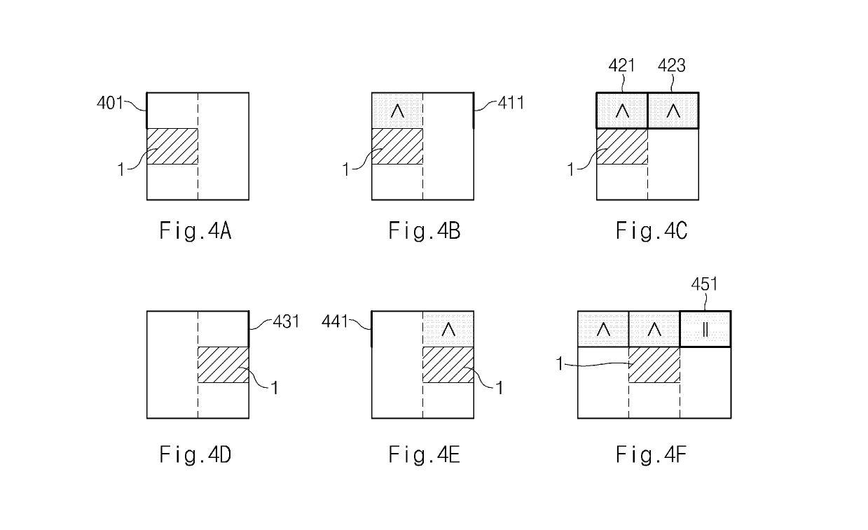

The operation for determining the current driving lane in the driving lane determiner 140 will be described with reference to FIGS. 4 to 6.

The output unit 150, executed by the processor, may be configured to output the driving lane information recognized as a determination result by the driving lane determiner 140. The output unit 150 may be configured to output the driving lane information as a voice or display the information on a monitor. Further, the driving lane information may be displayed on a map on the display of the navigator 10. When the driving lane determiner 140 fails to determine the current driving lane, the signal process unit 100 may be configured to output a message requesting to slow down the vehicle (e.g., reduce the vehicle speed) via the output unit 150.

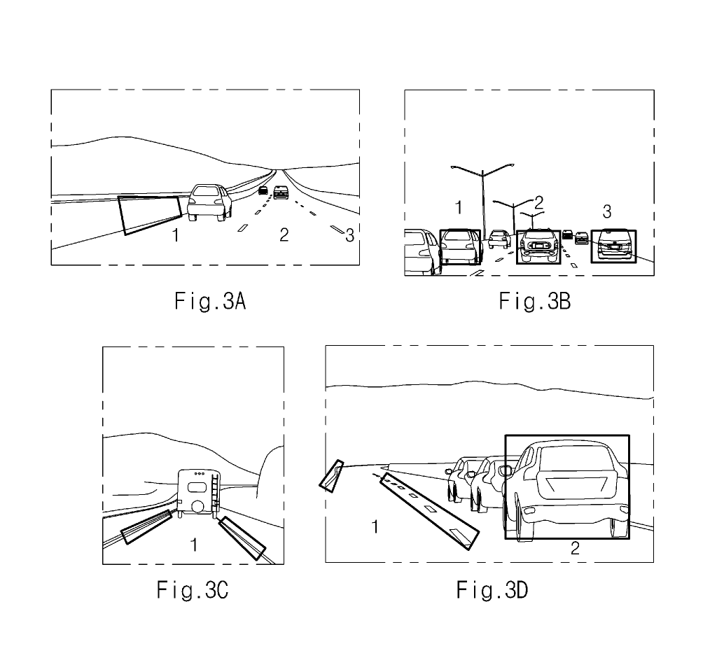

FIGS. 3A to 3D are exemplary diagrams for illustrating driving environment information according to an exemplary embodiment of the present invention, in which a front view of a vehicle is shown. At first, FIG. 3A illustrates when the position of a median strip is detected. The apparatus for recognizing driving lanes may be configured to recognize the current driving lane based on the number of total lanes and the position of the median strip.

Further, FIG. 3B illustrates when the positions of adjacent vehicles are detected. In particular, the apparatus for recognizing the driving lane may be configured to recognize the current driving lane based on the number of total lanes, the positions of vehicles in front, and in lanes on the left and right sides. Additionally, FIG. 3C illustrates when different types of driving lane lines are detected. The apparatus for recognizing the driving lane may be configured to recognize the current driving lane based on the type of left and right lines. In this case, when both left and right lines are solid lines, the apparatus for recognizing the driving lane may be configured to determine that the current driving lane is the first lane. FIG. 3D illustrates when the types of driving lane lines and the positions of adjacent vehicles are detected. The apparatus for recognizing the driving lane may be configured to recognize the number of total lanes, and combine the line types of driving lane and positions of adjacent vehicles to recognize the current driving lane.

FIGS. 4 to 6 are exemplary diagrams for illustrating the operation of recognizing the driving lane according to exemplary embodiments of the present invention.

FIGS. 4A to 4F show one direction (e.g., one side) of a four-lane road, in which the number of total lanes is two. In FIGS. 4A to 4C, the first lane is the driving lane, and in FIGS. 4D and 4F, the second lane is the driving lane. In FIG. 4A, the apparatus for recognizing the driving lane may be configured to detect that the number of total lanes is two and the left line of driving lane 401 is a solid line, and may be configured to recognize the driving lane in which a vehicle 1 is traveling is the first lane. FIG. 4B shows a situation when detecting the type of lines of driving lane is difficult due to vehicles traveling in front (e.g., ahead of vehicle 1). In particular, the apparatus for recognizing the driving lane may be configured to detect that the line of right adjacent lane 411 is a solid line, and may be configured to recognize the driving lane in which the vehicle 1 is traveling is the first lane. In FIG. 4C, the apparatus for recognizing the driving lane may be configured to detect that vehicles each in front and in lanes on the right side 421 and 423, and may be configured to recognize the driving lane in which the vehicle 1 is traveling is the first lane.

In FIG. 4D, the apparatus for recognizing the driving lane may be configured to detect that the number of total lanes is two and the right line of driving lane 431 is a solid line, and may be configured to recognize the driving lane in which the vehicle 1 is traveling is the second lane. FIG. 4E shows a situation when detecting the type of driving lines is difficult due to vehicles traveling in front. In particular, the apparatus for recognizing the driving lane may be configured to detect that the line of left adjacent lane 441 is a solid line, and may be configured to recognize the driving lane in which the vehicle 1 is traveling is the second lane. In FIG. 4F, the apparatus for recognizing the driving lane may be configured to detect a road boundary 451, and may be configured to recognize the driving lane in which the vehicle 1 is traveling is the second lane.

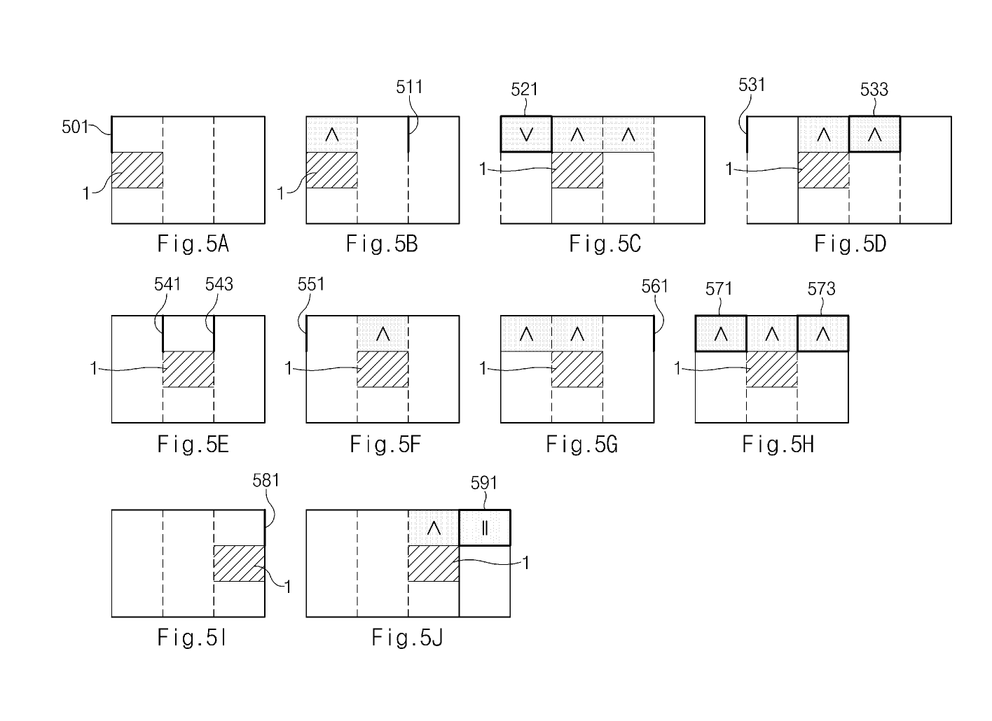

FIGS. 5A to 5J show one direction of a six-lane road, in which the number of total lanes is three. In FIGS. 5A to 5D the first lane is the driving lane, in FIGS. 5E to 5H the second lane is the driving lane, and in FIGS. 5I and 5J the third lane is the driving lane. In FIG. 5A, the apparatus for recognizing the driving lane may be configured to detect that the number of total lanes is three and the left line of driving lane 501 is a solid line, and may be configured to recognize the driving lane in which the vehicle 1 is traveling is the first lane. FIG. 5B shows a situation when detecting the type of lines of driving lane is difficult due to vehicles traveling in front. In this case, the apparatus for recognizing the driving lane may be configured to detect that the line of right adjacent lane 511 is a dashed line, and may be configured to recognize the driving lane in which the vehicle 1 is traveling is the first lane. In FIG. 5C, the apparatus for recognizing the driving lane may be configured to detect that a vehicle approaching from the opposite direction 521 is in the left lane, and may be configured to recognize the driving lane in which the vehicle 1 is traveling is the first lane. In FIG. 5D, the apparatus for recognizing the driving lane may be configured to detect that the line of left adjacent lane 531 is a dashed line and may be configured to detect a vehicle in the lane on right side 533, and may be configured to recognize that the line of left adjacent lane 531 is a line in the opposite direction and the driving lane in which the vehicle 1 is traveling is the first lane.

In FIG. 5E, the apparatus for recognizing the driving lane may be configured to detect that the number of total lanes is three and the left line and right line of driving lane 541 and 543 are dashed lines, and may be configured to recognize the driving lane in which the vehicle 1 is traveling is the second lane. FIG. 5F shows a situation when detecting the line type of driving lane is difficult due to vehicles traveling in front. In this case, the apparatus for recognizing the driving lane may be configured to detect that the line of left adjacent lane 551 is a solid line, and may be configured to recognize the driving lane in which the vehicle 1 is traveling is the second lane. In FIG. 5G, the apparatus for recognizing the driving lane may be configured to detect that the line of right adjacent lane 561 is a solid line, and may be configured to recognize the driving lane in which the vehicle 1 is traveling is the second lane. In FIG. 5H, the apparatus for recognizing the driving lane may be configured to detect that vehicles are in left and right lanes 571 and 573, and may be configured to recognize the driving lane in which the vehicle 1 is traveling is the second lane.

In FIG. 5I, the apparatus for recognizing the driving lane may be configured to detect that the number of total lanes is three and the right line of driving lane 581 is a solid line, and may be configured to recognize the driving lane in which the vehicle 1 is traveling is the third lane. In FIG. 5J, the apparatus for recognizing the driving lane may be configured to detect a road boundary 591 next to (e.g., adjacent to) the right line, and may be configured to recognize the driving lane in which the vehicle 1 is traveling is the third lane.

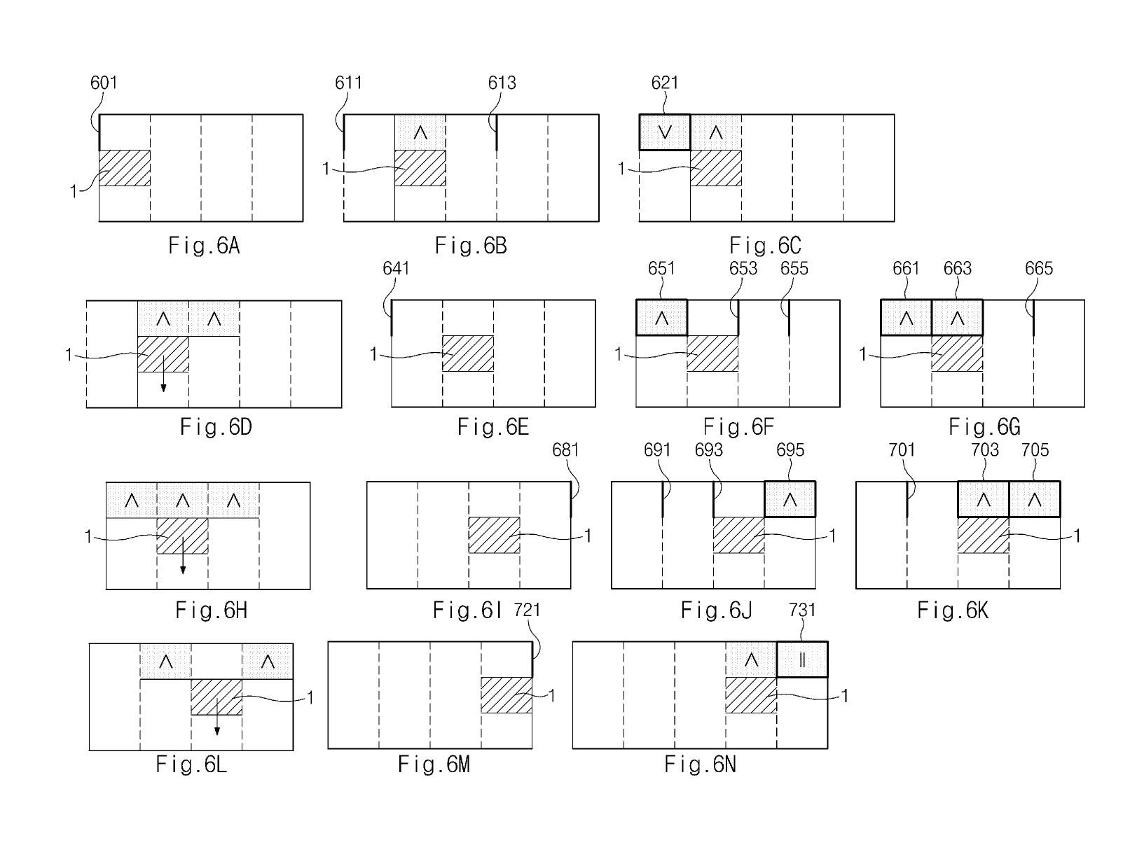

FIG. 6A to 6N show one direction of an eight-lane road, in which the number of total lanes is four. In FIGS. 6A to 6D the first lane is the driving lane, in FIGS. 6E to 6H the second lane is the driving lane, in FIGS. 61 and 63 the third lane is the driving lane, and in FIGS. 6M and 6N the fourth lane is the driving lane. In FIG. 6A, the apparatus for recognizing the driving lane may be configured to detect that the number of total lanes is four and the left line of driving lane 601 is a solid line, and may be configured to recognize the driving lane in which the vehicle 1 is traveling is the first lane. FIG. 6B shows a situation when detecting the type of lines of driving lane is difficult due to vehicles traveling in front. In this case, the apparatus for recognizing the driving lane may be configured to detect that the line of left adjacent lane 611 and the line of right adjacent lane 613 are dashed lines, and may be configured to recognize that the line of left adjacent lane 611 is the line in the opposite direction and the driving lane in which the vehicle 1 is traveling is the first lane. In FIG. 6C, the apparatus for recognizing the driving lane may be configured to detect that a vehicle approaching from the opposite direction 621 in the left lane, and may be configured to recognize the driving lane in which the vehicle 1 is traveling is the first lane.

In FIG. 6E, the apparatus for recognizing the driving lane may be configured to detect that the number of total lanes is four and the line of left adjacent lane 641 is a dashed line, and may be configured to recognize the driving lane in which the vehicle 1 is traveling is the second lane. In FIG. 6F, the apparatus for recognizing the driving lane may be configured to detect a vehicle located in left lane 651, and may be configured to detect that the line of right driving lane 653 and line of right adjacent lane 655 are dashed lines, and may be configured to recognize the driving lane in which the vehicle 1 is traveling is the second lane. In FIG. 6G, the apparatus for recognizing the driving lane may be configured to detect vehicles located in left and front lanes 661 and 663, and may be configured to detect that the line of right adjacent lane 665 is a dashed line, and may be configured to recognize the driving lane in which the vehicle 1 is traveling is the second lane.

In FIG. 61, the apparatus for recognizing the driving lane may be configured to detect that the number of total lanes is four and the line of right adjacent lane 681 is a solid line, and may be configured to recognize the driving lane in which the vehicle 1 is traveling is the third lane. In FIG. 6J, the apparatus for recognizing the driving lane may be configured to detect that the line of left adjacent lane 691 and left line of driving lane 693 are dashed lines, and may be configured to detect a vehicle located in the right lane, and may be configured to recognize the driving lane in which the vehicle 1 is traveling is the third lane. In FIG. 6K, the apparatus for recognizing the driving lane may be configured to detect that the line of left adjacent lane 701 is a dashed line, and may be configured to detect vehicles located in the front of vehicle 1, and in right lanes 703 and 705, respectively, and may be configured to recognize the driving lane in which the vehicle 1 is traveling is the third lane.

In FIG. 6M, the apparatus for recognizing the driving lane may be configured to detect that the right line of driving lane 721 is a solid line, and may be configured to recognize the driving lane in which the vehicle 1 is traveling is the fourth lane. In FIG. 6N, the apparatus for recognizing the driving lane may be configured to detect a road boundary 731 next to (e.g., adjacent to) the right line, and may be configured to recognize the driving lane in which the vehicle 1 is traveling is fourth lane. FIGS. 6D, 6H, and 6L illustrate when a driving lane is not recognized from the driving environment information, and the apparatus for recognizing the driving lane in this case may be configured to request to slow down the vehicle 1 (e.g., reduce the vehicle 1 speed).

An operation flow of the apparatus for recognizing the driving lane according to the exemplary embodiment of the present invention configured as described above will be described below in detail.

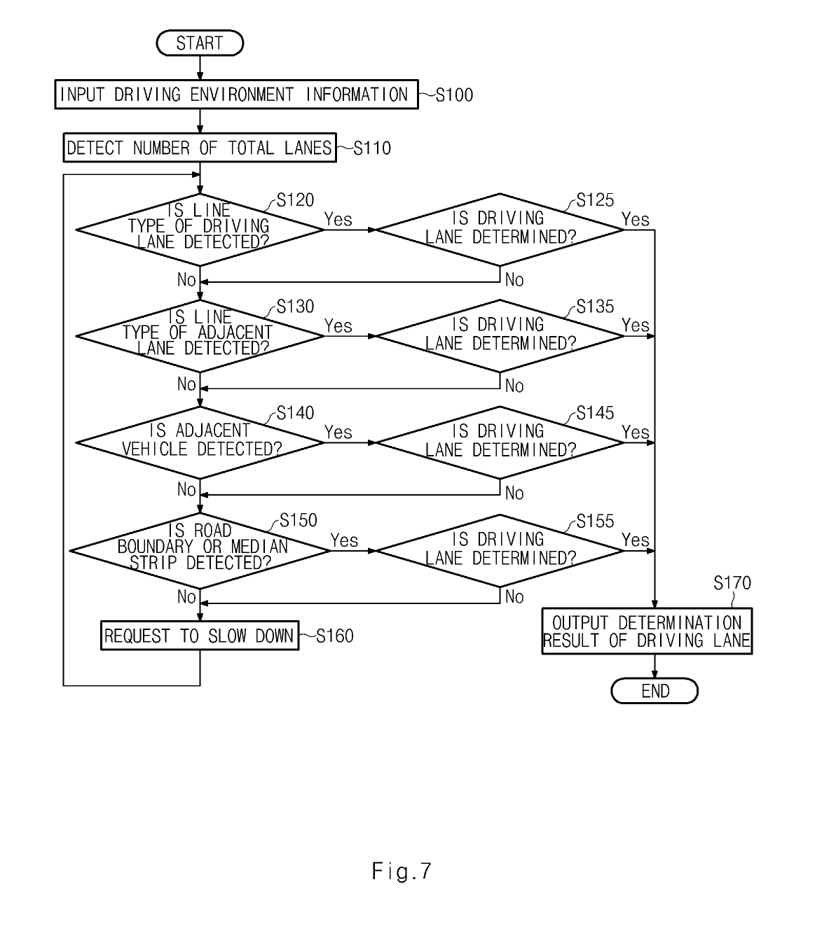

FIG. 7 is an exemplary flow chart showing an operation flow of a method for recognizing the driving lane according to the exemplary embodiment of the present invention. As shown in FIG. 7, the apparatus for recognizing the driving lane, executed by the processor, upon receiving information on the driving environment from a plurality of driving environment information detecting devices, e.g., a navigator, a camera, and a sensor (S100), may be configured to detect the number of total lanes based on the information input by the navigator in step S100 (S110).

When the line type of driving lane is detected from an image captured by the camera (S120), the apparatus may be configured to recognize the driving lane by combining the number of total lanes and types of lines of the driving lane, to output a result (S125, S170). When the apparatus fails to detect the line type of driving lane in step S120 or fails to recognize the driving lane in step S125, when the types of lines of adjacent lanes are detected from an image captured by the camera S130, the apparatus may be configured to recognize the driving lane by combining the number of total lanes and types of lines of the adjacent lanes, to output the result (S135, S170). In particular, in determining the driving lane in step S135, the information regarding the driving lane line types detected in step S120 may be combined.

Furthermore, when the apparatus fails to detect adjacent lanes in step S130, or fails to determine the driving lane in step S135, the apparatus may be configured to detect adjacent vehicles located in front, left and right lanes based on images captured by the camera or sensor values acquired by sensors (S140). In particular, the apparatus for recognizing the driving lane may be configured to determine the driving lane by combining the number of total lanes and positions of adjacent vehicles, to output the result (S145, S170). In determining the driving lane in step S145, the information regarding the types of driving lane lines detected in step S120 or the information regarding the types of lines of adjacent lanes detected in step S135 may be combined.

Additionally, when the apparatus fails to detect adjacent vehicles in step S140, or fails to determine the driving lane in step S145, the apparatus may be configured to detect a road boundary or a median strip based on images captured by the camera or sensor values acquired by sensors (S150). In particular, the apparatus for recognizing the driving lane may be configured to determine the driving lane by combining the number of total lanes and positions of the road boundary or median strip, to output the result (S155, S170). In determining the driving lane in step S155, the information regarding the driving environment detected in steps S120, S130 and S140 may be combined. In addition, when the apparatus fails to determine the driving lane even through steps S120 to S155, the apparatus may be configured to request to slow down the vehicle 5160 (e.g., request a vehicle speed reduction), and may repeat steps S120 to S155 when the vehicle travels at a lower speed.

As stated above, according to an exemplary embodiment of the present invention, the driving lane of a vehicle may be more accurately recognized by combining different types of information acquired by a plurality of collecting devices installed within the vehicle. In addition, according to the exemplary embodiment of the present invention, the driving lane of a vehicle may be recognized using collecting devices installed within a vehicle without requiring additional equipment for recognizing driving lane.

Although the apparatus and the method for recognizing a driving lane according to the exemplary embodiment of the present invention have been described with reference to the accompanying drawings, the present invention is not limited to the exemplary embodiment and the accompanying drawings disclosed in the present specification, but may be modified without departing from the scope and spirit of the present invention.

What is claimed is:

1. An apparatus for recognizing a driving lane, comprising:
a processor configured to:
detect pieces of driving environment information acquired by a plurality of driving environment information collecting devices installed within a vehicle;
determine the driving lane in which the vehicle is currently traveling by combining at least two pieces of the detected driving environment information; and
output recognized driving lane information as a result of the determination.

2. The apparatus according to claim 1, wherein the plurality of driving environment information collecting devices include: a navigator, a camera, and a sensor.

3. The apparatus according to claim 2, wherein the processor is further configured to:
detect a number of total lanes on a driving road based on the information acquired from the navigator; and
detect a line type of at least one of the driving lane or an adjacent lane, an adjacent vehicle, a road boundary and a median strip based on the driving environment information acquired from the camera or the sensor.

4. The apparatus according to claim 3, wherein the processor is further configured to:
recognize a first or a last lane based on at least whether the line type of driving or adjacent lane is a solid or dashed line, the side on which the solid line exists, and the color of the lines; and
determine the driving lane with reference to the number of total lanes and the recognized first or last lane.

5. The apparatus according to claim 3, wherein the processor is further configured to:
determine the driving lane based on the number of total lanes and a preceding vehicle traveling in a left or a right lane or position of an opposing vehicle traveling in an opposite direction.

6. The apparatus according to claim 3, wherein the processor is further configured to:
recognize the first or the last lane based on the position of the road boundary or the median strip; and
determine the driving lane with reference to the number of total lanes and the recognized first or last lane.

7. The apparatus according to claim 1, wherein the processor is further configured to:
output a message requesting a decrease in vehicle speed when the driving lane is not determined from the driving environment information.

8. A method for recognizing a driving lane, comprising:
detecting, by a processor, pieces of driving environment information acquired by a plurality of driving environment information collecting devices installed within a vehicle;
determining, by the processor, the driving lane in which the vehicle is currently traveling by combining at least two pieces of the detected driving environment information; and
outputting, by the processor, recognized driving lane information as a result of the determination.

9. The method according to claim 8, wherein the detecting of the driving environment information includes:
detecting, by the processor, a number of total lanes on a driving road based on the information acquired from the navigator; and
detecting, by the processor, at least one of a driving lane line type or an adjacent lane line type, an adjacent vehicle, a road boundary and a median strip based on the driving environment information acquired from the camera or the sensor.

10. The method according to claim 9, wherein the determining of the driving lane includes:
recognizing, by the processor, a first or a last lane based on at least whether the driving lane line type or the adjacent lane line type is a solid or dashed line, the side on which the solid exists, and the color of the lines; and
determining, by the processor, the driving lane with reference to the number of total lanes and the recognized first or last lane.

11. The method according to claim 9, wherein the determining of the driving lane includes:
determining, by the processor, the driving lane based on the number of total lanes and a preceding vehicle traveling in the left or right lane or an opposing vehicle traveling in an opposite lane.

12. The method according to claim 9, wherein the determining of the driving lane includes:
recognizing, by the processor, the first or the last lane based on the position of the road boundary or the median strip; and
determining, by the processor, the driving lane with reference to the number of total lanes and the recognized first or last lane.

13. The method according to claim 9, further comprising:
outputting, by the processor, a message requesting a reduction in the vehicle speed when the driving lane is not determined from the driving environment information in the determining of the driving lane.

14. A non-transitory computer readable medium containing program instructions executed by a processor, the computer readable medium comprising:
program instructions that detect pieces of driving environment information acquired by a plurality of driving environment information collecting devices installed within a vehicle;
program instructions that determine the driving lane in which the vehicle is currently traveling by combining at least two pieces of the detected driving environment information; and
program instructions that output recognized driving lane information as a result of the determination.

15. The non-transitory computer readable medium of claim 14, further comprising:
program instructions that detect a number of total lanes on a driving road based on the information acquired from the navigator; and
program instructions that detect at least one of a driving lane line type or an adjacent lane line type, an adjacent vehicle, a road boundary and a median strip based on the driving environment information acquired from the camera or the sensor.

16. The non-transitory computer readable medium of claim 14, further comprising:
program instructions that recognize a first or a last lane based on at least whether the driving lane line type or the adjacent lane line type is a solid or dashed line, the side on which the solid exists, and the color of the lines; and
program instructions that determine the driving lane with reference to the number of total lanes and the recognized first or last lane.

17. The non-transitory computer readable medium of claim 14, further comprising:
program instructions that determine the driving lane based on the number of total lanes and a preceding vehicle traveling in the left or right lane or an opposing vehicle traveling in an opposite lane.

18. The non-transitory computer readable medium of claim 14, further comprising:
program instructions that recognize the first or the last lane based on the position of the road boundary or the median strip; and
program instructions that determine the driving lane with reference to the number of total lanes and the recognized first or last lane.

19. The non-transitory computer readable medium of claim 14, further comprising:
program instructions that output a message requesting a reduction in the vehicle speed when the driving lane is not determined from the driving environment information in the determining of the driving lane.
